(19) United States
(12) Patent Application Publication
(10) Pub. No.: US 2025/0324376 A1
(43) Pub. Date: Oct. 16, 2025

(54) TIMING ADVANCE SIGNALING FOR MULTIPLE TRANSMIT RECEIVE POINTS

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Tao LUO, San Diego, CA (US)

(21) Appl. No.: 18/868,969

(22) PCT Filed: Jul. 13, 2022
(86) PCT No.: PCT/CN2022/105402

§ 371 Date: Nov. 25, 2024

(51) Int. Cl. H04W 56/00; H04W 74/0833

(52) U.S. Cl. CPC H04W 56/0045; H04W 74/0833

(57) ABSTRACT

Various aspects of the present disclosure generally relate to wireless communication. In some aspects, a user equipment (UE) may receive a configuration that specifies a first resource pool for a first timing advance (TA) operation with a first transmit receive point (TRP) and a second resource pool for a second TA operation with a second TRP, the first resource pool being associated with a first downlink reference timing and the second resource pool being associated with a second downlink reference timing. The UE may transmit a first communication to the first TRP using the first TA operation. The UE may transmit a second communication to the second TRP using the second TA operation. Numerous other aspects are described.

### FIELD OF THE DISCLOSURE

Aspects of the present disclosure generally relate to wireless communication and to techniques and apparatuses for timing advance signaling for multiple transmit receive points.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration that specifies a first resource pool for a first timing advance (TA) operation with a first transmit receive point (TRP) and a second resource pool for a second TA operation with a second TRP. The first resource pool may be associated with a first downlink reference timing and the second resource pool may be associated with a second downlink reference timing. The method may include transmitting a first communication to the first TRP using the first TA operation. The method may include transmitting a second communication to the second TRP using the second TA operation.

Some aspects described herein relate to a method of wireless communication performed by a network entity. The method may include transmitting a configuration that specifies a first resource pool for a first TA operation with a first TRP and a second resource pool for a second TA operation with a second TRP. The first resource pool may be associated with a first downlink reference timing and the second resource pool may be associated with a second downlink reference timing. The method may include receiving a first communication to the first TRP using the first TA operation. The method may include receiving a second communication to the second TRP using the second TA operation.

Some aspects described herein relate to a UE for wireless communication. The UE may include a memory and one or more processors coupled to the memory. The one or more processors may be configured to receive a configuration that specifies a first resource pool for a first TA operation with a first TRP and a second resource pool for a second TA operation with a second TRP, the first resource pool being associated with a first downlink reference timing and the second resource pool being associated with a second downlink reference timing. The one or more processors may be configured to transmit a first communication to the first TRP using the first TA operation. The one or more processors may be configured to transmit a second communication to the second TRP using the second TA operation.

Some aspects described herein relate to a network entity for wireless communication. The network entity may include a memory and one or more processors coupled to the memory. The one or more processors may be configured to transmit a configuration that specifies a first resource pool for a first TA operation with a first TRP and a second resource pool for a second TA operation with a second TRP, the first resource pool being associated with a first downlink reference timing and the second resource pool being associated with a second downlink reference timing. The one or more processors may be configured to receive a first communication to the first TRP using the first TA operation. The one or more processors may be configured to receive a second communication to the second TRP using the second TA operation.

Some aspects described herein relate to a non-transitory computer-readable medium that stores a set of instructions for wireless communication by a UE. The set of instructions, when executed by one or more processors of the UE, may cause the UE to receive a configuration that specifies a first resource pool for a first TA operation with a first TRP and a second resource pool for a second TA operation with a second TRP, the first resource pool being associated with a first downlink reference timing and the second resource pool being associated with a second downlink reference timing. The set of instructions, when executed by one or more processors of the UE, may cause the UE to transmit a first communication to the first TRP using the first TA operation. The set of instructions, when executed by one or more processors of the UE, may cause the UE to transmit a second communication to the second TRP using the second TA operation.

Some aspects described herein relate to a non-transitory computer-readable medium that stores a set of instructions for wireless communication by a network entity. The set of instructions, when executed by one or more processors of the network entity, may cause the network entity to transmit a configuration that specifies a first resource pool for a first TA operation with a first TRP and a second resource pool for a second TA operation with a second TRP, the first resource pool being associated with a first downlink reference timing and the second resource pool being associated with a second downlink reference timing. The set of instructions, when executed by one or more processors of the network entity, may cause the network entity to receive a first communication to the first TRP using the first TA operation. The set of instructions, when executed by one or more processors of the network entity, may cause the network entity to receive a second communication to the second TRP using the second TA operation.

Some aspects described herein relate to an apparatus for wireless communication. The apparatus may include means for receiving a configuration that specifies a first resource pool for a first TA operation with a first TRP and a second resource pool for a second TA operation with a second TRP, the first resource pool being associated with a first downlink reference timing and the second resource pool being associated with a second downlink reference timing. The apparatus may include means for transmitting a first communication to the first TRP using the first TA operation. The apparatus may include means for transmitting a second communication to the second TRP using the second TA operation.

Some aspects described herein relate to an apparatus for wireless communication. The apparatus may include means for transmitting a configuration that specifies a first resource pool for a first TA operation with a first TRP and a second resource pool for a second TA operation with a second TRP, the first resource pool being associated with a first downlink reference timing and the second resource pool being associated with a second downlink reference timing. The apparatus may include means for receiving a first communication to the first TRP using the first TA operation. The apparatus may include means for receiving a second communication to the second TRP using the second TA operation.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 illustrates an example logical architecture of a distributed radio access network, in accordance with the present disclosure.

FIG. 5 is a diagram illustrating an example of multiple transmit receive point (TRP) communication, in accordance with the present disclosure.

FIG. 6 is a diagram illustrating an example of a timing advance (TA) configuration, in accordance with the present disclosure.

FIG. 7 is a diagram illustrating an example of configuring multiple TAs for multiple TRPs, in accordance with the present disclosure.

FIG. 8 is a diagram illustrating an example process performed, for example, by a UE, in accordance with the present disclosure.

FIG. 9 is a diagram illustrating an example process performed, for example, by a network entity, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

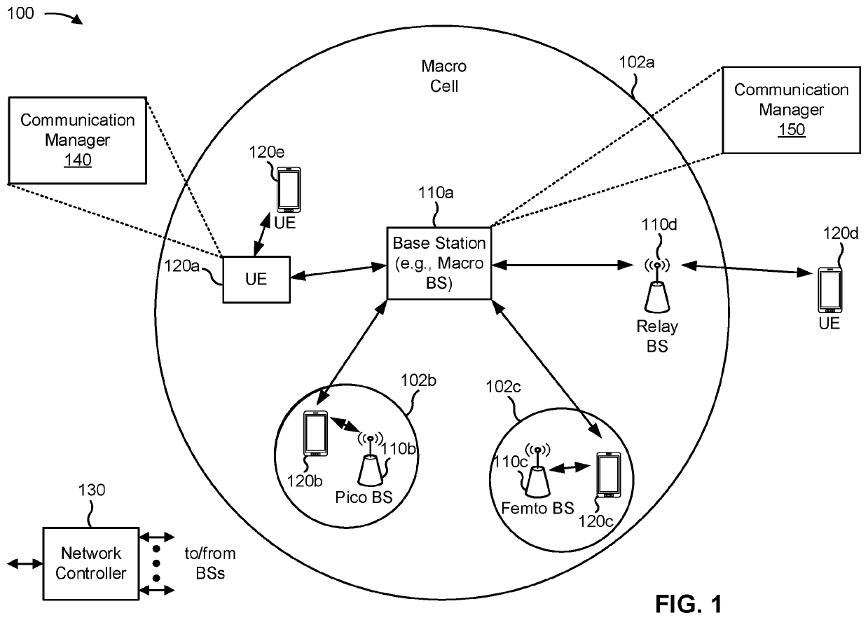

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmit receive point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration that specifies a first resource pool for a first timing advance (TA) operation with a first TRP and a second resource pool for a second TA operation with a second TRP, the first resource pool being associated with a first downlink reference timing and the second resource pool being associated with a second downlink reference timing. The communication manager 140 may transmit a first communication to the first TRP using the first TA operation and transmit a second communication to the second TRP using the second TA operation. Additionally, or alternatively, the communication manager 140 may perform one or more other operations described herein.

In some aspects, a network entity (e.g., base station 110) may include a communication manager 150. As described in more detail elsewhere herein, the communication manager 150 may transmit a configuration that specifies a first resource pool for a first TA operation with a first TRP and a second resource pool for a second TA operation with a second TRP, the first resource pool being associated with a first downlink reference timing and the second resource pool being associated with a second downlink reference timing. The communication manager 150 may receive a first communication to the first TRP using the first TA operation and receive a second communication to the second TRP using the second TA operation. Additionally, or alternatively, the communication manager 150 may perform one or more other operations described herein.

As indicated above, FIG. 1 is provided as an example. Other examples may differ from what is described with regard to FIG. 1.

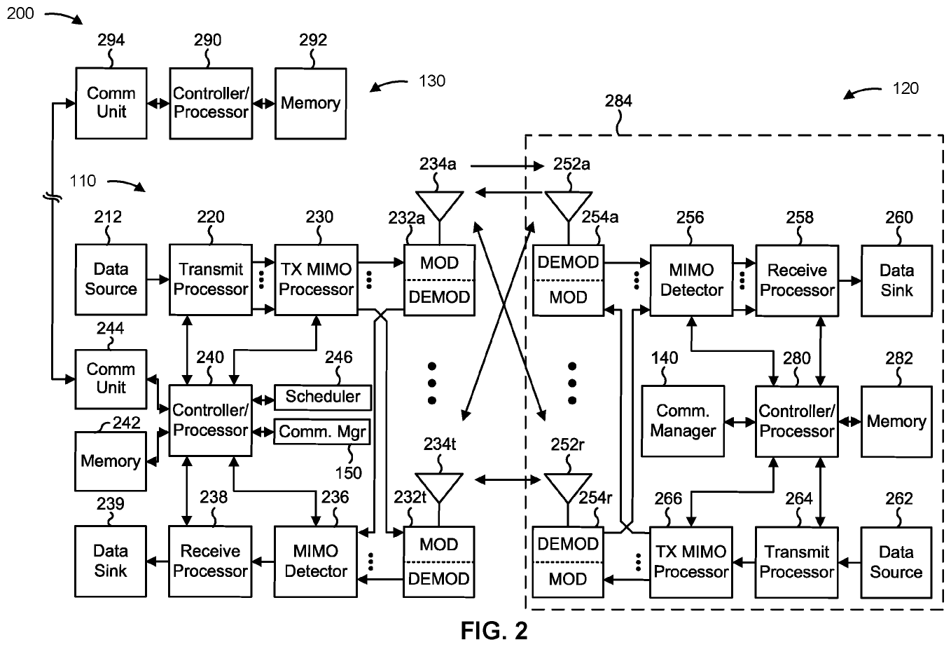

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

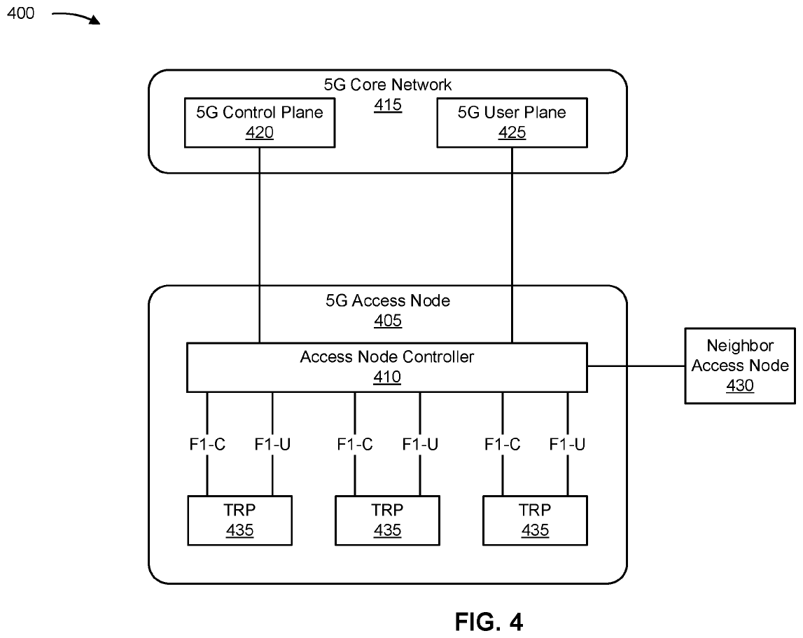

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM) and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-11).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-11).

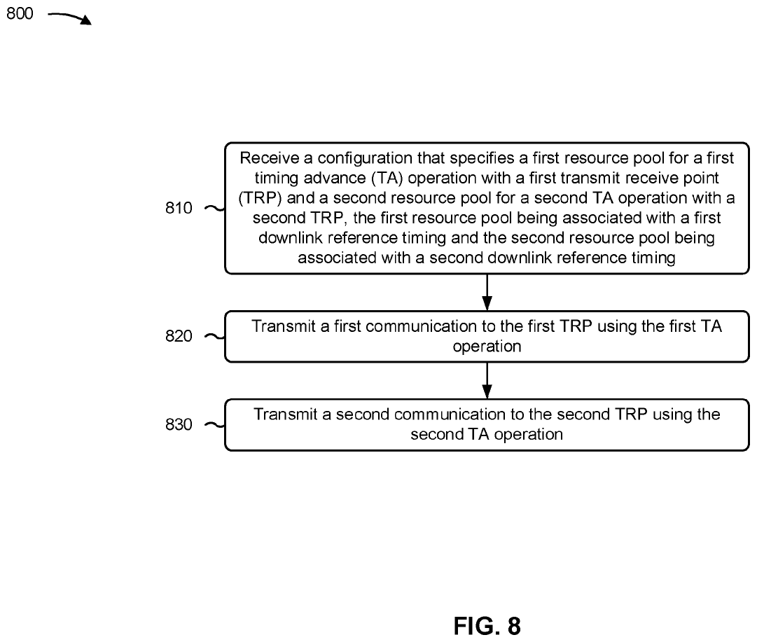

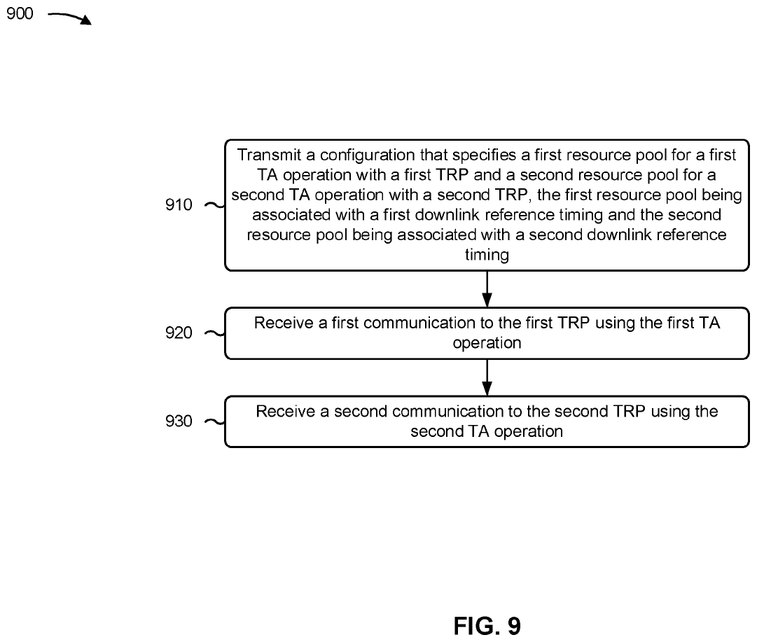

A controller/processor of a network entity (e.g., the controller/processor 240 of the base station 110), the controller/processor 280 of the UE 120 (mobile station), and/or any other component(s) of FIG. 2) may perform one or more techniques associated with signaling TAs for multiple TRPs, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving a configuration that specifies a first resource pool for a first TA operation with a first TRP and a second resource pool for a second TA operation with a second TRP, the first resource pool being associated with a first downlink reference timing and the second resource pool being associated with a second downlink reference timing; means for transmitting a first communication to the first TRP using the first TA operation; and/or means for transmitting a second communication to the second TRP using the second TA operation. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., base station 110) includes means for transmitting a configuration that specifies a first resource pool for a first TA operation with a first TRP and a second resource pool for a second TA operation with a second TRP, the first resource pool being associated with a first downlink reference timing and the second resource pool being associated with a second downlink reference timing; means for receiving a first communication to the first TRP using the first TA operation; and/or means for receiving a second communication to the second TRP using the second TA operation. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

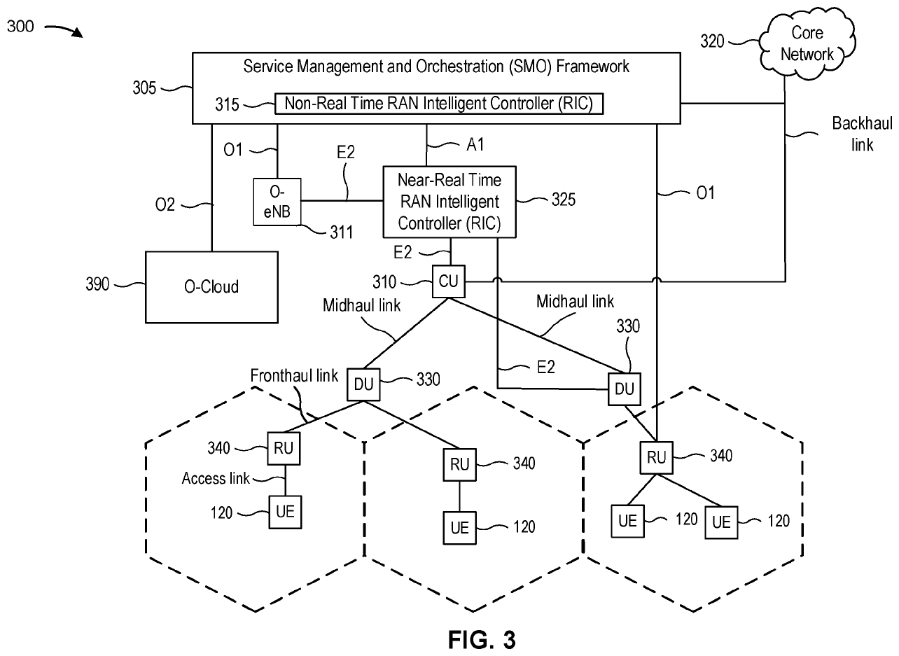

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 3 shows a diagram illustrating an example disaggregated base station 300 architecture. The disaggregated base station 300 architecture may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more radio frequency (RF) access links. In some aspects, the UE 120 may be simultaneously served by multiple RUs 340. The DUs 330 and the RUs 340 may also be referred to as “O-RAN DUS (O-DUs”) and “O-RAN RUs (O-RUS)”, respectively. A network entity at the RAN may include a CU, a DU, an RU, or any combination of CUs, DUs, and RUs. A network entity at the RAN may include a disaggregated base station or one or more components of the disaggregated base station, such as a CU, a DU, an RU, or any combination of CUs, DUs, and RUs. A network entity at the RAN may also include one or more of a TRP, a relay station, a passive device, an intelligent reflective surface (IRS), or other components that may provide a network interface for or serve a UE, mobile station, sensor/actuator, or other wireless device.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 illustrates an example logical architecture of a distributed RAN 400, in accordance with the present disclosure.

A 5G access node 405 may include an access node controller 410. The access node controller 410 may be a CU of the distributed RAN 400 (e.g., disaggregated base station). In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a DU of the distributed RAN 400. In some aspects, a TRP 435 may correspond to a base station 110 described above in connection with FIG. 1. For example, different TRPs 435 may be included in different base stations 110. Additionally, or alternatively, multiple TRPs 435 may be included in a single base station 110. In some aspects, a base station 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a PDCP layer, a RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi-co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

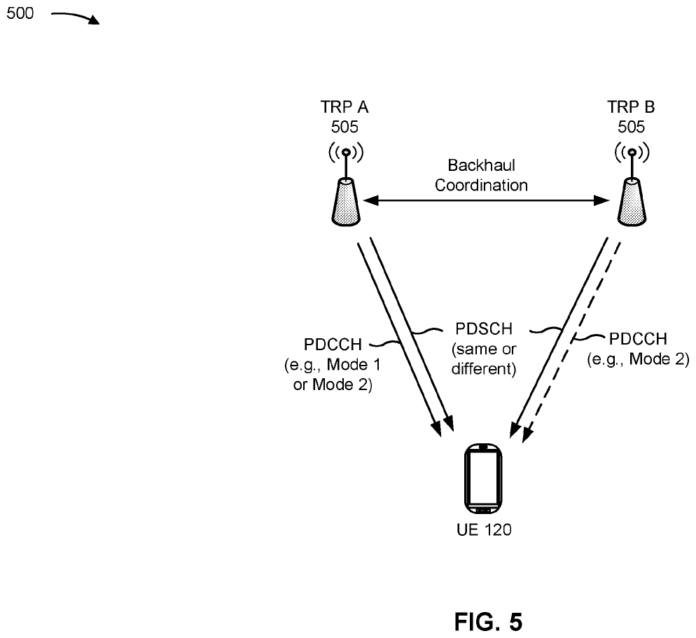

FIG. 5 is a diagram illustrating an example 500 of multi-TRP communication (sometimes referred to as multi-panel communication), in accordance with the present disclosure. As shown in FIG. 5, multiple TRPs 505 may communicate with the same mobile station (e.g., same UE 120). A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same base station 110 (e.g., when the TRPs 505 are different antenna arrays or panels of the same base station 110) and may have a larger delay and/or lower capacity (as compared to co-location) when the TRPs 505 are located at different base stations 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1). A UE may receive multiple DCI (mDCI) from the multiple TRPs or a single DCI (sDCI) for the multiple TRPs.

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

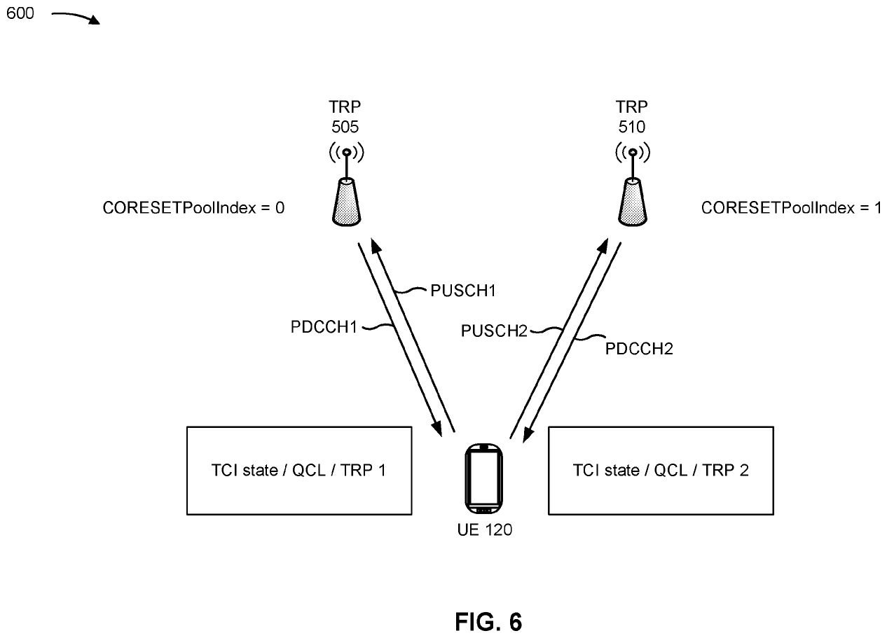

FIG. 6 is a diagram illustrating an example 600 of a TA configuration, in accordance with the present disclosure.

A UE (e.g., a UE 120) may use a TA to adjust when the UE 120 transmits a communication, in order to align an arrival time for the communication with a subframe timing at a TRP (e.g., TRP 505, TRP 510) or another network entity. The network entity may transmit a TA command (e.g., in a MAC CE via the TRP) that includes a TA value (e.g., time duration) that indicates how early the UE 120 is to transmit a communication to account for the propagation delay. For example, a single downlink timing may be used, where the same TA is used for multiple communications from the first TRP 505 and the second TRP 505. There may be two TAs because the two TRPs may be at different distances. Accordingly, a separate downlink timing may be used, where different TAs are used for different communications.

If there are multiple serving cells, TA groups (TAGs) may be used. A TAG may include one or more serving cells with the same TA for an uplink carrier. One of the serving cells may be a timing reference cell for the entire TAG. RRC signaling may map each serving cell to a TAG, which may be identified with a TAG identifier (ID) in a TA command MAC control element (CE).

TAs may be configured for multiple TRP (mTRP) operations, which may include single downlink control information (sDCI) or multiple DCI (mDCI) mTRP operations. In mDCI mTRP operation, each TRP may be associated with a control resource set (CORESET) pool index. Example 600 shows that TRP 505 may be associated with CORESETs of CORESET pool index 0 (zero) or of no CORESET pool index and TRP 510 may be associated with CORESETs of CORESET pool index 1.

A network entity (e.g., a base station 110) may configure the UE 120 with TCI states for uplink channels or reference signals and then activate the TCI states. Different TCI states may be activated or indicated for different channels and reference signals for different TRPs. Example 600 shows a first TCI state for an uplink channel (PUCCH1) to TRP 505. The first TCI state for the uplink channel may be QCLed with a TCI state for PDCCH1, which is associated with TRP 505, and represented as TCI state/QCL/TRP 1. Example 600 also shows a second TCI state for an uplink channel (PUCCH2) to TRP 510. The second TCI state for the uplink channel may be QCLed with a TCI state for PDCCH2, which is associated with TRP 510, and represented as TCI state/QCL/TRP 2.

TAGs may be used for mTRP operations. For example, for TRP 505 and TRP 510, the UE 120 may be enabled with two TAs for mTRP operation, where different TAs may be applied to different TRPs. The UE 120 may be configured with two TAGs per serving cell, and each TAG (or corresponding indicator or TAG ID) may be configured within or associated with each uplink or joint (uplink/downlink) TCI state. Alternatively, the UE 120 may be configured with two TAs within one TAG within a serving cell.

A TA configuration may be for multiple cells and for a common bandwidth part (BWP). An mTRP configuration may be CC-specific and BWP-specific. However, it has not been specified how a UE is to be configured with multiple TA values in order to enable mDCI asynchronous mTRP operation, which uses multiple DCI (multi-DCI) to schedule communications on multiple TRPs asynchronously, or without a fixed schedule. If the UE does not have timing certainty in mTRP operations, communications may degrade, and processing resources and signaling resources may be wasted.

As indicated above, FIG. 6 is provided as an example. Other examples may differ from what is described with regard to FIG. 6.

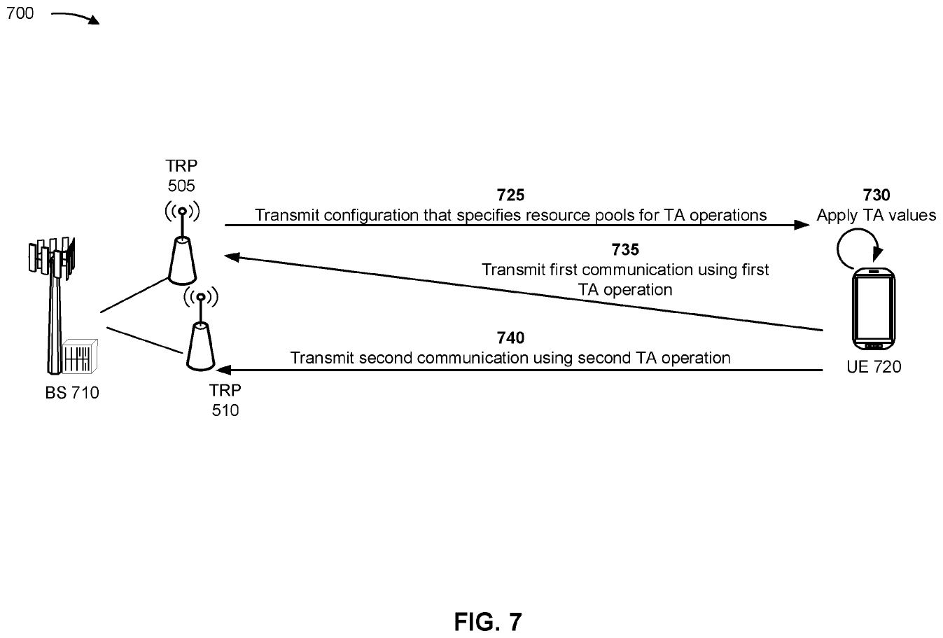

FIG. 7 is a diagram illustrating an example 700 of configuring multiple TAs for multiple TRPs, in accordance with the present disclosure. As shown in FIG. 7, a network entity 710 (e.g., base station 110) and a UE 720 (e.g., a UE 120) may communicate with one another. The network entity 710 may control at least two TRPs, such as TRP 505 and TRP 510. Each TRP may be associated with a CORESET pool index and one or more serving cells.

According to various aspects described herein, a network entity may configure a UE with at least one TA operation per CC for mDCI asynchronous mTRP operations (e.g., communications with multiple TRPs). A TA operation may include the application of a TA value for uplink transmission associated with a TRP. The UE 720 may be configured with at least two resource pools for at least two TA operations. Each resource pool may be associated with a downlink reference timing, which is a reference timing in downlink relative to the timing for the TA value in uplink. The downlink reference timing may be calculated per TRP. Each resource pool may be associated with a TA operation. For example, the resource pool may be a list of synchronization signal blocks (SSBs). When multiple physical cell identifiers (PCIs) are configured for a serving cell, the SSBs of the same PCI may be in the same resource pool.

In some aspects, the UE 720 may support two TA operations per CC for mDCI asynchronous mTRP operation with radio resource control (RRC) configuration options. For example, the network entity 710 may configure the UE 720 with two TAG IDs per serving cell in the serving cell configuration, and the two TAG IDs may be used for different TRPs, if mDCI mTRP is configured in a BWP of the serving cells. Alternatively, the network entity 710 may configure the UE 720 with one TAG ID with two TA operations per serving cell in the serving cell configuration. For different TRPs, the two TA values may be obtained in various ways. For example, the network entity 710 may indicate a TA value for a TAG that is a common reference for both TRPs. The network entity 710 may also indicate two TA offsets for both TRPs, where the amount of the TA value for each TRP is derived based on the TA value and the TA offset associated with the corresponding TRP. In another example, the network entity 710 may indicate a first TA value of a TAG for the first TRP, and a TA offset for the second TRP with respect to the first TRP, where the amount of the TA value for the second TRP is derived based on the first TA value and the TA offset. In yet another example, the network entity 710 may indicate the first TA value for the first TRP, and use a flag to indicate that the UE 720 is to implicitly derive the second TA value based on a difference in the downlink timing references for the resource pools for the TRPs, where the amount of the TA value for the second TRP is derived based on the first TA value and the time difference between a downlink timing reference for the first TRP and a downlink timing reference for the second TRP. The flag may be an explicit flag in an RRC configuration. In some aspects, the flag may be an implicit flag. The implicit flag may include the UE 720 being configured with multiple (e.g., two) resource pools. For example, when the UE 720 is configured with two resource pools and two TA operations, the UE may apply the amount of the TA value for the second TRP based on the first TA value and the time difference between two downlink timing references for the two TRPs.

Example 700 shows configuration of the UE 720 for two TA operations. As shown by reference number 725, the network entity 710 may transmit a configuration that specifies a first resource pool for a first TA operation with TRP 505 and a second resource pool for a second TA operation with TRP 510. The first resource pool may be associated with a first downlink reference timing, and the second resource pool may be associated with a second downlink reference timing. The configuration may specify two TA operations per CC for mDCI mTRP operations. The configuration may specify two TAG IDs per serving cell, the two TAG IDs being associated with different TRPs. The configuration may specify one TAG ID with two TA operations per serving cell. As shown by reference number 730, the UE 720 may apply the TA values, the first TA value in a first TA operation for TRP 505 and the second TA value in a second TA operation for TRP 510.

In some aspects, the configuration may specify a TA value that is a common reference for TRP 505 and TRP 510. The configuration may also specify a first TA offset for TRP 505 and a second TA offset for TRP 510 that is relative to the common reference. Alternatively, the configuration may specify a first TA value for TRP 505 and a TA offset for TRP 510 that is with respect to TRP 505. In some aspects, the configuration may specify a first TA value for TRP 505 and specify that a second TA value for TRP 510 is to be derived from a difference between the first downlink reference timing and the second downlink reference timing. The UE 720 may determine the second TA value based at least in part on the difference. The configuration may include a flag (e.g., one or more bits) that specifies that the second TA value is to be derived from the difference. The UE 720 may determine that the second TA value is to be derived from the difference based at least in part on being configured with the first resource pool and the second resource pool.

In some aspects, the configuration may specify an association between the two TA values (e.g., a first TA value from a TAG and a second TA value that is indicated or derived) and different uplink channels. The configuration may also associate a first TA value with a first CORESET pool index and a second TA value with a second CORESET pool index. For example, the UE 720 may apply a first TA value for uplink channels associated with CORESET pool index 0 (zero) or with no CORESET pool index. The UE 720 may apply a second TA value for uplink channels associated with CORESET pool index 1. In another example, the network entity 710 may indicate a first TA value that is associated with TRP 505, or one CORESET pool index. The UE 720 may apply the first TA value for uplink channels associated with the associated CORESET pool index and the second TA value for uplink channels not associated with the associated CORESET pool index.

In some aspects, the UE 720 may report the difference between the first downlink reference timing and the second downlink reference timing. The UE 720 may then transmit an indication of a first downlink reference timing for TRP 505 and a downlink reference timing for TRP 510 based at least in part on the difference satisfying a difference threshold (e.g., a maximum time difference in milliseconds or symbols). If the difference does not satisfy the difference threshold, the network entity 710 may transmit an indication of a first TA value for TRP 505, and the UE 720 may determine a second TA value for TRP 510 based at least in part on the first TA value.

In some aspects, the UE 720 may report the difference between the first TA value and the second TA value. The UE 720 may then transmit an indication of a first TA value for the first TRP and a second TA value for the second TRP based at least in part on the difference satisfying a difference threshold (e.g., a maximum time difference in milliseconds or symbols). If the difference does not satisfy the difference threshold, the network entity 710 may transmit an indication of a first TA value for TRP 505, and the UE 720 may determine a second TA value for TRP 510 based at least in part on the first TA value.

In some aspects, the network entity 710 may configure at least two TA values to enable mDCI asynchronous mTRP operations. The UE 720 may be configured with at least two TA operations per CC for mDCI asynchronous mTRP operations. The UE 720 may receive TA indications (that indicate TA values) and may perform TA operations based on when the TA indications are received. For example, the UE 720 may apply a single TA value (as part of a TA operation) for both TRP 505 and TRP 510 after receiving a first TA indication for TRP 505 and before receiving a second TA indication or any random access triggers (e.g., trigger for a physical random access channel (PRACH)) for TRP 510. The single TA value may be used if a single resource pool is configured.

Alternatively, or additionally, the UE 720 may not receive the second TA indication but may derive the second TA value if two resource pools are configured. UE 720 may then determine the second TA value based at least in part on the first TA value. The UE 720 may make this determination after receiving the first TA indication and before receiving the second TA indication or a random access trigger for TRP 510.

In some aspects, the UE 720 may not expect to schedule any transmission except PRACH and thus the UE 720 may wait to schedule a transmission other than a random access channel message from TRP 510, after receiving the first TA indication and before receiving the second TA indication or a random access trigger for TRP 510. In some aspects, the UE 720 may apply a second TA value from a msg2 (of a random access channel (RACH) procedure) during an initial access for TRP 510 after receiving the first TA indication and before receiving the second TA indication or a random access trigger for TRP 510.

As shown by reference number 735, the UE 720 may transmit a first communication, such as data on a physical uplink shared channel (PUSCH), using the first TA operation, which applies the first TA value for TRP 505. As shown by reference number 740, the UE 720 may transmit a second communication, such as data on the PUSCH, using the second TA operation that applies the second TA value for TRP 510.

By configuring the UE 720 with two resource pools for two TA operations with multiple TRPs, the UE 720 may have more accurate timing for communications with multiple TRPs. As a result, communications may improve, which reduces latency and conserves processing resources and signaling resources.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., a UE 120, UE 720) performs operations associated with TA signaling for multiple TRPs.

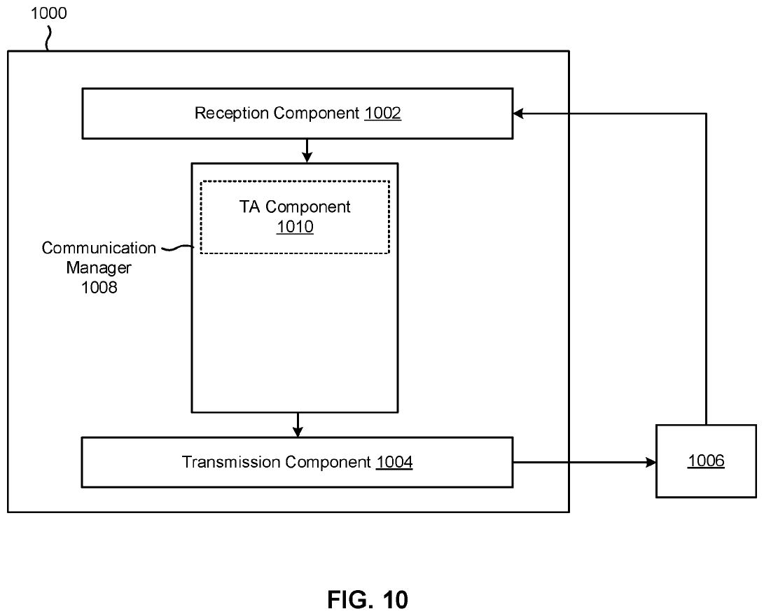

As shown in FIG. 8, in some aspects, process 800 may include receiving a configuration that specifies a first resource pool for a first TA operation with a first TRP and a second resource pool for a second TA operation with a second TRP, the first resource pool being associated with a first downlink reference timing and the second resource pool being associated with a second downlink reference timing (block 810). For example, the UE (e.g., using communication manager 1008 and/or reception component 1002 depicted in FIG. 10) may receive a configuration that specifies a first resource pool for a first TA operation with a first TRP and a second resource pool for a second TA operation with a second TRP, the first resource pool being associated with a first downlink reference timing and the second resource pool being associated with a second downlink reference timing, as described above.

As further shown in FIG. 8, in some aspects, process 800 may include transmitting a first communication to the first TRP using the first TA operation (block 820). For example, the UE (e.g., using communication manager 1008 and/or transmission component 1004 depicted in FIG. 10) may transmit a first communication to the first TRP using the first TA operation, as described above.

As further shown in FIG. 8, in some aspects, process 800 may include transmitting a second communication to the second TRP using the second TA operation (block 830). For example, the UE (e.g., using communication manager 1008 and/or transmission component 1004 depicted in FIG. 10) may transmit a second communication to the second TRP using the second TA operation, as described above.

Process 800 may include additional aspects, such as any single aspect or any combination of aspects described below and/or in connection with one or more other processes described elsewhere herein.

In a first aspect, the configuration specifies two TA operations per CC for multiple DCI for multiple TRPs.

In a second aspect, alone or in combination with the first aspect, process 800 includes applying a TA value for both the first TRP and the second TRP after receiving a first TA indication for the first TRP and before receiving a second TA indication or random access trigger for the second TRP.

In a third aspect, alone or in combination with one or more of the first and second aspects, process 800 includes determining a second TA value for the second TRP based at least in part on a first TA value for the first TRP, based at least in part on the UE being configured with the first resource pool and the second resource pool, after receiving a first TA indication of the first TA value, and before receiving a second TA indication or random access trigger for the second TRP.

In a fourth aspect, alone or in combination with one or more of the first through third aspects, process 800 includes waiting to schedule a transmission other than a random access channel message from the second TRP after receiving a first TA indication for the first TRP and before receiving a second TA indication or random access trigger for the second TRP.

In a fifth aspect, alone or in combination with one or more of the first through fourth aspects, process 800 includes applying a second TA value from a msg2 during an initial access for the second TRP after receiving a first TA indication of a first TRP value for the first TRP and before receiving a second TA indication or random access trigger for the second TRP.

In a sixth aspect, alone or in combination with one or more of the first through fifth aspects, the configuration specifies two TAG IDs per serving cell, the two TAG IDs being associated with different TRPs.

In a seventh aspect, alone or in combination with one or more of the first through sixth aspects, the configuration specifies one TAG ID with two TA operations per serving cell.

In an eighth aspect, alone or in combination with one or more of the first through seventh aspects, the configuration specifies a TA value that is a common reference for the first TRP and the second TRP, a first TA offset for the first TRP, and a second TA offset for the second TRP.

In a ninth aspect, alone or in combination with one or more of the first through eighth aspects, the configuration specifies a first TA value for the first TRP and a TA offset for the second TRP that is with respect to the first TRP.

In a tenth aspect, alone or in combination with one or more of the first through ninth aspects, the configuration specifies a first TA value for the first TRP and that a second TA value for the second TRP is to be derived from a difference between the first downlink reference timing and the second downlink reference timing, and process 800 includes determining the second TA value based at least in part on the difference.

In an eleventh aspect, alone or in combination with one or more of the first through tenth aspects, the configuration includes a flag that specifies that the second TA value is to be derived from the difference.

In a twelfth aspect, alone or in combination with one or more of the first through eleventh aspects, process 800 includes determining that the second TA value is to be derived from the difference based at least in part on being configured with the first resource pool and the second resource pool.

In a thirteenth aspect, alone or in combination with one or more of the first through twelfth aspects, the configuration associates a first TA value with a first CORESET pool index and a second TA value with a second CORESET pool index.

In a fourteenth aspect, alone or in combination with one or more of the first through thirteenth aspects, process 800 includes transmitting a report of a difference between the first downlink reference timing and the second downlink reference timing.

In a fifteenth aspect, alone or in combination with one or more of the first through fourteenth aspects, process 800 includes receiving an indication of a first TA value for the first TRP and a second TA value for the second TRP based at least in part on the difference satisfying a difference threshold.

In a sixteenth aspect, alone or in combination with one or more of the first through fifteenth aspects, process 800 includes receiving an indication of a first TA value for the first TRP, and determining a second TA value for the second TRP based at least in part on the first TA value.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., base station 110, network entity 710) performs operations associated with configuring TA operations for multiple TRPs.

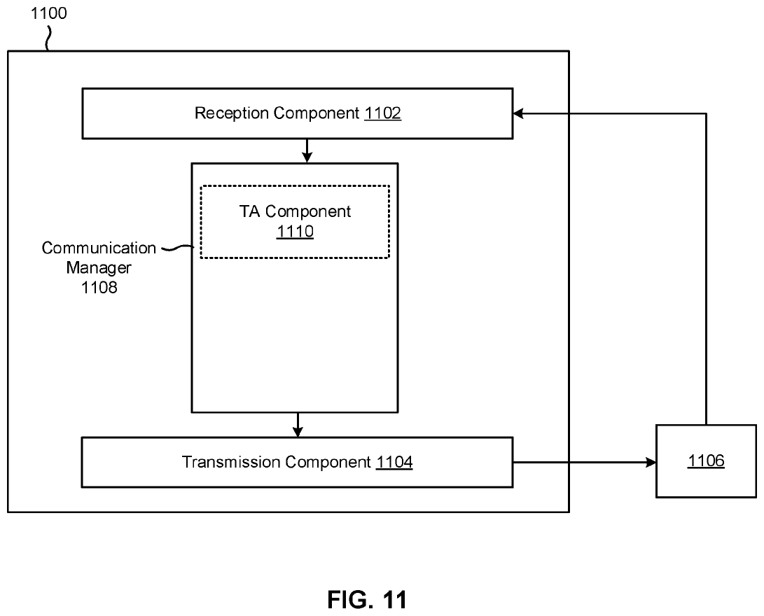

As shown in FIG. 9, in some aspects, process 900 may include transmitting a configuration that specifies a first resource pool for a first TA operation with a first TRP and a second resource pool for a second TA operation with a second TRP, the first resource pool being associated with a first downlink reference timing and the second resource pool being associated with a second downlink reference timing (block 910). For example, the network entity (e.g., using communication manager 1108 and/or transmission component 1104 depicted in FIG. 11) may transmit a configuration that specifies a first resource pool for a first TA operation with a first TRP and a second resource pool for a second TA operation with a second TRP, the first resource pool being associated with a first downlink reference timing and the second resource pool being associated with a second downlink reference timing, as described above.

As further shown in FIG. 9, in some aspects, process 900 may include receiving a first communication to the first TRP using the first TA operation (block 920). For example, the network entity (e.g., using communication manager 1108 and/or reception component 1102 depicted in FIG. 11) may receive a first communication to the first TRP using the first TA operation, as described above.

As further shown in FIG. 9, in some aspects, process 900 may include receiving a second communication to the second TRP using the second TA operation (block 930). For example, the network entity (e.g., using communication manager 1108 and/or reception component 1102 depicted in FIG. 11) may receive a second communication to the second TRP using the second TA operation, as described above.

Process 900 may include additional aspects, such as any single aspect or any combination of aspects described below and/or in connection with one or more other processes described elsewhere herein.

In a first aspect, the configuration specifies two TA operations per CC for multiple downlink control information for multiple TRPs.

In a second aspect, alone or in combination with the first aspect, the configuration specifies two TAG IDs per serving cell, the two TAG IDs being associated with different TRPs.

In a third aspect, alone or in combination with one or more of the first and second aspects, the configuration specifies one TAG ID with two TA operations per serving cell.

In a fourth aspect, alone or in combination with one or more of the first through third aspects, the configuration specifies a TA value that is a common reference for the first TRP and the second TRP, a first TA offset for the first TRP, and a second TA offset for the second TRP.

In a fifth aspect, alone or in combination with one or more of the first through fourth aspects, the configuration specifies a first TA value for the first TRP and a TA offset for the second TRP that is with respect to the first TRP.

In a sixth aspect, alone or in combination with one or more of the first through fifth aspects, the configuration specifies a first TA value for the first TRP and that a second TA value for the second TRP is to be derived from a difference between the first downlink reference timing and the second downlink reference timing.

In a seventh aspect, alone or in combination with one or more of the first through sixth aspects, the configuration includes a flag that specifies that the second TA value is to be derived from the difference.

In an eighth aspect, alone or in combination with one or more of the first through seventh aspects, the configuration associates a first TA value with a first CORESET pool index and a second TA value with a second CORESET pool index.

In a ninth aspect, alone or in combination with one or more of the first through eighth aspects, process 900 includes receiving a report of a difference between the first downlink reference timing and the second downlink reference timing, and transmitting an indication of a first TA value for the first TRP and a second TA value for the second TRP based at least in part on the difference satisfying a difference threshold.

In a tenth aspect, alone or in combination with one or more of the first through ninth aspects, process 900 includes receiving a report of a difference between the first downlink reference timing and the second downlink reference timing, and transmitting a first TA value for the first TRP based at least in part on the difference not satisfying a difference threshold.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE (e.g., a UE 120, UE 720), or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 1008. The communication manager 1008 may control and/or otherwise manage one or more operations of the reception component 1002 and/or the transmission component 1004. In some aspects, the communication manager 1008 may include one or more antennas, a modem, a controller/processor, a memory, or a combination thereof, of the UE described in connection with FIG. 2. The communication manager 1008 may be, or be similar to, the communication manager 140 depicted in FIGS. 1 and 2. For example, in some aspects, the communication manager 1008 may be configured to perform one or more of the functions described as being performed by the communication manager 140. In some aspects, the communication manager 1008 may include the reception component 1002 and/or the transmission component 1004. The communication manager 1008 may include a TA component 1010, among other examples.

In some aspects, the apparatus 1000 may be configured to perform one or more operations described herein in connection with FIGS. 1-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive a configuration that specifies a first resource pool for a first TA operation with a first TRP and a second resource pool for a second TA operation with a second TRP, the first resource pool being associated with a first downlink reference timing and the second resource pool being associated with a second downlink reference timing. The transmission component 1004 may transmit a first communication to the first TRP using the first TA operation. The transmission component 1004 may transmit a second communication to the second TRP using the second TA operation.

The TA component 1010 may apply a TA value for both the first TRP and the second TRP after receiving a first TA indication for the first TRP and before receiving a second TA indication or random access trigger for the second TRP.

The TA component 1010 may determine a second TA value for the second TRP based at least in part on a first TA value for the first TRP, based at least in part on the UE being configured with the first resource pool and the second resource pool, after receiving a first TA indication of the first TA value, and before receiving a second TA indication or random access trigger for the second TRP.

The transmission component 1004 may wait to schedule a transmission other than a RACH message from the second TRP after receiving a first TA indication for the first TRP and before receiving a second TA indication or random access trigger for the second TRP.

The TA component 1010 may apply a second TA value from a msg2 during an initial access for the second TRP after receiving a first TA indication of a first TRP value for the first TRP and before receiving a second TA indication or random access trigger for the second TRP. The TA component 1010 may determine that the second TA value is to be derived from the difference based at least in part on being configured with the first resource pool and the second resource pool.

The transmission component 1004 may transmit a report of a difference between the first downlink reference timing and the second downlink reference timing. The reception component 1002 may receive an indication of a first TA value for the first TRP and a second TA value for the second TRP based at least in part on the difference satisfying a difference threshold. The reception component 1002 may receive an indication of a first TA value for the first TRP. The TA component 1010 may determine a second TA value for the second TRP based at least in part on the first TA value.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network entity (e.g., base station 110, network entity 710), or a network entity may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 1108. The communication manager 1108 may control and/or otherwise manage one or more operations of the reception component 1102 and/or the transmission component 1104. In some aspects, the communication manager 1108 may include one or more antennas, a modem, a controller/processor, a memory, or a combination thereof, of the network entity described in connection with FIG. 2. The communication manager 1108 may be, or be similar to, the communication manager 150 depicted in FIGS. 1 and 2. For example, in some aspects, the communication manager 1108 may be configured to perform one or more of the functions described as being performed by the communication manager 1108. In some aspects, the communication manager 1108 may include the reception component 1102 and/or the transmission component 1104. The communication manager 1108 may include a configuration component 1110, among other examples.

In some aspects, the apparatus 1100 may be configured to perform one or more operations described herein in connection with FIGS. 1-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network entity described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network entity described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network entity described in connection with FIG. 2. In some aspects, the transmission component 1104 may be co-located with the reception component 1102 in a transceiver.

The transmission component 1104 may transmit a configuration that specifies a first resource pool for a first TA operation with a first TRP and a second resource pool for a second TA operation with a second TRP, the first resource pool being associated with a first downlink reference timing and the second resource pool being associated with a second downlink reference timing. The configuration component 1110 may generate the configuration based at least in part on a network topology, a UE capability, traffic conditions at the TRPs, and/or channel conditions for the TRPs. The reception component 1102 may receive a first communication to the first TRP using the first TA operation. The reception component 1102 may receive a second communication to the second TRP using the second TA operation.

The reception component 1102 may receive a report of a difference between the first downlink reference timing and the second downlink reference timing. The transmission component 1104 may transmit an indication of a first TA value for the first TRP and a second TA value for the second TRP based at least in part on the difference satisfying a difference threshold.

The reception component 1102 may receive a report of a difference between the first downlink reference timing and the second downlink reference timing. The transmission component 1104 may transmit a first TA value for the first TRP based at least in part on the difference not satisfying a difference threshold.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving a configuration that specifies a first resource pool for a first timing advance (TA) operation with a first transmit receive point (TRP) and a second resource pool for a second TA operation with a second TRP, the first resource pool being associated with a first downlink reference timing and the second resource pool being associated with a second downlink reference timing; transmitting a first communication to the first TRP using the first TA operation; and transmitting a second communication to the second TRP using the second TA operation.

Aspect 2: The method of Aspect 1, wherein the configuration specifies two TA operations per component carrier (CC) for multiple downlink control information for multiple TRPs.

Aspect 3: The method of Aspect 2, further comprising applying a TA value for both the first TRP and the second TRP after receiving a first TA indication for the first TRP and before receiving a second TA indication or random access trigger for the second TRP.

Aspect 4: The method of Aspect 2, further comprising determining a second TA value for the second TRP based at least in part on a first TA value for the first TRP, based at least in part on the UE being configured with the first resource pool and the second resource pool, after receiving a first TA indication of the first TA value, and before receiving a second TA indication or random access trigger for the second TRP.

Aspect 5: The method of Aspect 2, further comprising waiting to schedule a transmission other than a random access channel message from the second TRP after receiving a first TA indication for the first TRP and before receiving a second TA indication or random access trigger for the second TRP.

Aspect 6: The method of Aspect 2, further comprising applying a second TA value from a msg2 during an initial access for the second TRP after receiving a first TA indication of a first TRP value for the first TRP and before receiving a second TA indication or random access trigger for the second TRP.

Aspect 7: The method of any of Aspects 1-6, wherein the configuration specifies two TA group (TAG) identifiers (IDs) per serving cell, the two TAG IDs being associated with different TRPs.

Aspect 8: The method of any of Aspects 1-7, wherein the configuration specifies one TA group identifier with two TA operations per serving cell.

Aspect 9: The method of any of Aspects 1-8, wherein the configuration specifies a TA value that is a common reference for the first TRP and the second TRP, a first TA offset for the first TRP, and a second TA offset for the second TRP.

Aspect 10: The method of any of Aspects 1-8, wherein the configuration specifies a first TA value for the first TRP and a TA offset for the second TRP that is with respect to the first TRP.

Aspect 11: The method of any of Aspects 1-8, wherein the configuration specifies a first TA value for the first TRP and that a second TA value for the second TRP is to be derived from a difference between the first downlink reference timing and the second downlink reference timing, and wherein the method comprises determining the second TA value based at least in part on the difference.

Aspect 12: The method of Aspect 11, wherein the configuration includes a flag that specifies that the second TA value is to be derived from the difference.

Aspect 13: The method of Aspect 11 or 12, further comprising determining that the second TA value is to be derived from the difference based at least in part on being configured with the first resource pool and the second resource pool.

Aspect 14: The method of any of Aspects 1-13, wherein the configuration associates a first TA value with a first control resource set (CORESET) pool index and a second TA value with a second CORESET pool index.

Aspect 15: The method of any of Aspects 1-14, further comprising transmitting a report of a difference between the first downlink reference timing and the second downlink reference timing.

Aspect 16: The method of Aspect 15, further comprising receiving an indication of a first TA value for the first TRP and a second TA value for the second TRP based at least in part on the difference satisfying a difference threshold.

Aspect 17: The method of Aspect 15, further comprising, based at least in part on the difference not satisfying a difference threshold: receiving an indication of a first TA value for the first TRP; and determining a second TA value for the second TRP based at least in part on the first TA value.

Aspect 18: A method of wireless communication performed by a network entity, comprising: transmitting a configuration that specifies a first resource pool for a first timing advance (TA) operation with a first transmit receive point (TRP) and a second resource pool for a second TA operation with a second TRP, the first resource pool being associated with a first downlink reference timing and the second resource pool being associated with a second downlink reference timing; receiving a first communication to the first TRP using the first TA operation; and receiving a second communication to the second TRP using the second TA operation.

Aspect 19: The method of Aspect 18, wherein the configuration specifies two TA operations per component carrier (CC) for multiple downlink control information for multiple TRPs.

Aspect 20: The method of Aspect 18 or 19, wherein the configuration specifies two TA group (TAG) identifiers (IDs) per serving cell, the two TAG IDs being associated with different TRPs.

Aspect 21: The method of any of Aspects 18-20, wherein the configuration specifies one TA group identifier with two TA operations per serving cell.

Aspect 22: The method of any of Aspects 18-21, wherein the configuration specifies a TA value that is a common reference for the first TRP and the second TRP, a first TA offset for the first TRP, and a second TA offset for the second TRP.

Aspect 23: The method of any of Aspects 18-21, wherein the configuration specifies a first TA value for the first TRP and a TA offset for the second TRP that is with respect to the first TRP.

Aspect 24: The method of any of Aspects 18-21, wherein the configuration specifies a first TA value for the first TRP and that a second TA value for the second TRP is to be derived from a difference between the first downlink reference timing and the second downlink reference timing.

Aspect 25: The method of Aspect 24, wherein the configuration includes a flag that specifies that the second TA value is to be derived from the difference.

Aspect 26: The method of any of Aspects 18-25, wherein the configuration associates a first TA value with a first control resource set (CORESET) pool index and a second TA value with a second CORESET pool index.

Aspect 27: The method of any of Aspects 18-26, further comprising: receiving a report of a difference between the first downlink reference timing and the second downlink reference timing; and transmitting an indication of a first TA value for the first TRP and a second TA value for the second TRP based at least in part on the difference satisfying a difference threshold.

Aspect 28: The method of any of Aspects 18-26, further comprising: receiving a report of a difference between the first downlink reference timing and the second downlink reference timing; and transmitting a first TA value for the first TRP based at least in part on the difference not satisfying a difference threshold.

Aspect 29: An apparatus for wireless communication at a device, comprising a processor; memory coupled with the processor; and instructions stored in the memory and executable by the processor to cause the apparatus to perform the method of one or more of Aspects 1-28.

Aspect 30: A device for wireless communication, comprising a memory and one or more processors coupled to the memory, the one or more processors configured to perform the method of one or more of Aspects 1-28.

Aspect 31: An apparatus for wireless communication, comprising at least one means for performing the method of one or more of Aspects 1-28.

Aspect 32: A non-transitory computer-readable medium storing code for wireless communication, the code comprising instructions executable by a processor to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a configuration that specifies a first resource pool for a first timing advance (TA) operation with a first transmit receive point (TRP) and a second resource pool for a second TA operation with a second TRP, the first resource pool being associated with a first downlink reference timing and the second resource pool being associated with a second downlink reference timing;
transmit a first communication to the first TRP using the first TA operation; and
transmit a second communication to the second TRP using the second TA operation.

2. The UE of claim 1, wherein the configuration specifies two TA operations per component carrier (CC) for multiple downlink control information for multiple TRPs.

3. The UE of claim 2, wherein the one or more processors are configured to apply a TA value for both the first TRP and the second TRP after receiving a first TA indication for the first TRP and before receiving a second TA indication or random access trigger for the second TRP.

4. The UE of claim 2, wherein the one or more processors are configured to determine a second TA value for the second TRP based at least in part on a first TA value for the first TRP, based at least in part on the UE being configured with the first resource pool and the second resource pool, after receiving a first TA indication of the first TA value, and before receiving a second TA indication or random access trigger for the second TRP.

5. The UE of claim 2, wherein the one or more processors are configured to wait to schedule a transmission other than a random access channel message from the second TRP after receiving a first TA indication for the first TRP and before receiving a second TA indication or random access trigger for the second TRP.

6. The UE of claim 2, wherein the one or more processors are configured to apply a second TA value from a msg2 during an initial access for the second TRP after receiving a first TA indication of a first TRP value for the first TRP and before receiving a second TA indication or random access trigger for the second TRP.

7. The UE of claim 1, wherein the configuration specifies two TA group (TAG) identifiers (IDs) per serving cell, the two TAG IDs being associated with different TRPs.

8. The UE of claim 1, wherein the configuration specifies one TA group identifier with two TA operations per serving cell.

9. The UE of claim 1, wherein the configuration specifies a TA value that is a common reference for the first TRP and the second TRP, a first TA offset for the first TRP, and a second TA offset for the second TRP.

10. The UE of claim 1, wherein the configuration specifies a first TA value for the first TRP and a TA offset for the second TRP that is with respect to the first TRP.

11. The UE of claim 1, wherein the configuration specifies a first TA value for the first TRP and that a second TA value for the second TRP is to be derived from a difference between the first downlink reference timing and the second downlink reference timing, and wherein the one or more processors are configured to determine the second TA value based at least in part on the difference.

12. The UE of claim 11, wherein the configuration includes a flag that specifies that the second TA value is to be derived from the difference.

13. The UE of claim 11, wherein the one or more processors are configured to determine that the second TA value is to be derived from the difference based at least in part on being configured with the first resource pool and the second resource pool.

14. The UE of claim 1, wherein the configuration associates a first TA value with a first control resource set (CORESET) pool index and a second TA value with a second CORESET pool index.

15. The UE of claim 1, wherein the one or more processors are configured to transmit a report of a difference between the first downlink reference timing and the second downlink reference timing.

16. The UE of claim 15, wherein the one or more processors are configured to receive an indication of a first TA value for the first TRP and a second TA value for the second TRP based at least in part on the difference satisfying a difference threshold.

17. The UE of claim 15, wherein the one or more processors are configured to, based at least in part on the difference not satisfying a difference threshold:
receive an indication of a first TA value for the first TRP; and
determine a second TA value for the second TRP based at least in part on the first TA value.

18. A network entity for wireless communication, comprising:
a memory; and
one or more processors, coupled to the memory, configured to:
transmit a configuration that specifies a first resource pool for a first timing advance (TA) operation with a first transmit receive point (TRP) and a second resource pool for a second TA operation with a second TRP, the first resource pool being associated with a first downlink reference timing and the second resource pool being associated with a second downlink reference timing;
receive a first communication to the first TRP using the first TA operation; and
receive a second communication to the second TRP using the second TA operation.

19. The network entity of claim 18, wherein the configuration specifies two TA operations per component carrier (CC) for multiple downlink control information for multiple TRPs.

20. The network entity of claim 18, wherein the configuration specifies two TA group (TAG) identifiers (IDs) per serving cell, the two TAG IDs being associated with different TRPs.

21. The network entity of claim 18, wherein the configuration specifies one TA group identifier with two TA operations per serving cell.

22. The network entity of claim 18, wherein the configuration specifies a TA value that is a common reference for the first TRP and the second TRP, a first TA offset for the first TRP, and a second TA offset for the second TRP.

23. The network entity of claim 18, wherein the configuration specifies a first TA value for the first TRP and a TA offset for the second TRP that is with respect to the first TRP.

24. The network entity of claim 18, wherein the configuration specifies a first TA value for the first TRP and that a second TA value for the second TRP is to be derived from a difference between the first downlink reference timing and the second downlink reference timing.

25. The network entity of claim 24, wherein the configuration includes a flag that specifies that the second TA value is to be derived from the difference.

26. The network entity of claim 18, wherein the configuration associates a first TA value with a first control resource set (CORESET) pool index and a second TA value with a second CORESET pool index.

27. The network entity of claim 18, wherein the one or more processors are configured to:
receive a report of a difference between the first downlink reference timing and the second downlink reference timing; and
transmit an indication of a first TA value for the first TRP and a second TA value for the second TRP based at least in part on the difference satisfying a difference threshold.

28. The network entity of claim 18, wherein the one or more processors are configured to:
receive a report of a difference between the first downlink reference timing and the second downlink reference timing; and
transmit a first TA value for the first TRP based at least in part on the difference not satisfying a difference threshold.

29. A method of wireless communication performed by a user equipment (UE), comprising:
receiving a configuration that specifies a first resource pool for a first timing advance (TA) operation with a first transmit receive point (TRP) and a second resource pool for a second TA operation with a second TRP, the first resource pool being associated with a first downlink reference timing and the second resource pool being associated with a second downlink reference timing;
transmitting a first communication to the first TRP using the first TA operation; and
transmitting a second communication to the second TRP using the second TA operation.

30. A method of wireless communication performed by a network entity, comprising:
transmitting a configuration that specifies a first resource pool for a first timing advance (TA) operation with a first transmit receive point (TRP) and a second resource pool for a second TA operation with a second TRP, the first resource pool being associated with a first downlink reference timing and the second resource pool being associated with a second downlink reference timing;
receiving a first communication to the first TRP using the first TA operation; and
receiving a second communication to the second TRP using the second TA operation.
